(19) United States
(12) Patent Application Publication
(10) Pub. No.: US 2012/0051875 A1
(43) Pub. Date: Mar. 1, 2012

(54) VEHICLE SIDE DUMPING PLATFORM

(75) Inventors: Gary Teichrob, Chilliwack (CA); James Easden, Chilliwack (CA)

(73) Assignee: TY-CROP MANUFACTURING LTD., Rosedale (CA)

(21) Appl. No.: 12/868,075

(22) Filed: Aug. 25, 2010

(51) Int. Cl. B65G 67/50; B65G 67/24

(52) U.S. Cl. 414/359; 414/809

(57) ABSTRACT

A vehicle side dumping apparatus is provided comprising a pivotable deck for supporting and tipping a vehicle, and one or more piston-cylinder assemblies configured for tipping the deck. A piston rod of each piston-cylinder assembly has a first end pivotally supported against a support surface. A coupling assembly mechanically and pivotally couples the deck to the cylinder at a coupling location of the cylinder, wherein the coupling assembly is configured to substantially axially load the piston-cylinder assembly. The coupling location is located near the cylinder end receiving the piston rod, substantially in line with the vehicle deck, the remainder of the cylinder extending above the vehicle deck.

### FIELD OF THE INVENTION

The present invention pertains in general to material handling and in particular to a method and apparatus for side dumping a container vehicle.

### BACKGROUND

In material handling, side dumping or side tipping refers to the process of discharging a material, such as mined concentrates, from a vehicular mounted container in a direction lateral to the main axis or direction of travel of the vehicle. The discharged material is then transferred by gravity to a location alongside the vehicle. This process differs from end dumping where the discharge is in a direction axial to the vehicle and whereby the resultant material location is typically to the rear of the vehicle.

Side dumping may be achieved by self-dumping, whereby the vehicle incorporates a lifting mechanism. The lifting mechanism rotates a container, hinged axially relative to the vehicle, to affect a gravitational discharge of material from the container. However, the inclusion of the lifting mechanism adds weight and complexity to a vehicle.

To avoid this problem, stationary side dumping or tipping platforms may be employed, for example at a terminus of a haul route traversed by a multi-vehicle fleet. Such a device consists of a hinged platform, onto which the entire vehicle may be driven. The platform is capable of rotating and raising such that the container payload of the vehicle may be discharged, under gravity, to a location alongside and adjacent to the side dumping platform.

Side dumping, when compared to end dumping, may provide for one or more advantages. For example, since the relative spacing between the payload center and the axis of rotation is smaller than in end dumping, the height to which the container must be raised to affect discharge is significantly less than is required for the same vehicle in an end dump configuration. This facilitates reduced component sizing and improved safety of operation. The reduced height of dumping operations further allows for side dumping system to be fitted within buildings of restricted size. This is of particular relevance where the payload is to be kept free of rain, snow or other contaminants. In addition, in side dumping, the discharged load may be spread along the full length of the container, which may be as long as the vehicle allows, therefore the load is less concentrated and the load pile lower than would be achieved by an equivalent end dump. This allows side dumping to be completed at grade. End dumping, in comparison, could only be completed at grade level if the vehicle was slowly moving forward. Furthermore, in side dumping, the load is discharged away from the vehicle's tires. This has significant environmental and operational advantages as the opportunity for contamination is eliminated.

Typically, side dumping platforms are constructed with a raised deck located at the upper extremity of a structure, with all lifting mechanisms located below the deck. This arrangement has the advantage of allowing minimal-stroke single-stage hydraulic cylinders as the primary means of raising or tilting the deck. Such hydraulic cylinders are desirable as low-maintenance and adequately powerful actuators for performing the required lifting for a side dumping platform. However such a structure requires significant clearance beneath the deck to house the hydraulic cylinders and the structure against which the cylinders bear. Consequently side dump platforms are typically elevated significantly above grade, require extensive supporting structure and are permanently located at a fixed site. Such elevation also requires extensive ramping of the roadway at the ingress and egress from the platform. This may make side dumping platforms an expensive undertaking in some situations.

FIGS. 1A and 1B illustrate a cross-sectional schematic view of a prior art vehicle side-tipping apparatus 100. A vehicle deck 110 is mounted to ground or another support structure at a rolling pivot 122, which rolls over the ground as it pivots. A piston-cylinder assembly comprising a piston rod 135 and a cylinder 140 is configured for tilting the vehicle deck 110. The cylinder 140 is supported against ground or another support structure at a support location 142 and a free end of the piston rod is coupled to the vehicle deck at a pivoting coupling point 137. FIG. 1A illustrates the apparatus 100 with the vehicle deck 110 horizontal for drive-on and drive-off, while FIG. 1B illustrates the apparatus 100 with the vehicle deck 110 tilted for dumping vehicle contents.

Referring to FIG. 1A, the piston-cylinder assembly has a minimum length 150, which necessitates a portion of the apparatus 100 to be provided below the level of the vehicle deck 110. This can require excavation below the vehicle deck 110, or alternatively elevation of the vehicle deck 110 and access thereto via ramping. As illustrated, the support location 142 is located at a distance 170 below the rolling pivot 122, which is typically no less than length 150 of the cylinder 140. As illustrated in FIG. 1B, the combined length of the cylinder 140 and piston rod 135 has a maximum length 160, which typically approaches twice the minimum length 150 for non-telescoping assemblies. As the maximum length 160 is roughly a multiple of the minimum length 150, the maximum tipping angle of the vehicle deck is an increasing function of the minimum length 150. This arrangement may be problematic at least in that substantial clearance is required below the vehicle deck 110.

Therefore there is a need for a method and apparatus for supporting and side dumping of a container vehicle that is not subject to one or more limitations of the prior art.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a vehicle side dumping platform. In accordance with an aspect of the present invention, there is provided an apparatus for side dumping of a container vehicle, the apparatus comprising: a deck for supporting the container vehicle, the deck pivotable about a longitudinal axis; a piston-cylinder assembly configured for pivoting the deck, a piston rod portion of the piston-cylinder assembly having a first end thereof supported against a support surface, a cylinder of the piston-cylinder assembly having an open end for receiving a second end of the piston rod portion, and a second cylinder end opposite the cylinder open end; and a coupling assembly configured to mechanically couple the deck to the cylinder at a coupling location of the cylinder, the coupling location between the cylinder open end and the second cylinder end; wherein the piston-cylinder assembly is configured for coupling to an actuating system for actuating the piston-cylinder assembly between an extended position and a retracted position, thereby pivoting the deck.

In accordance with another aspect of the present invention, there is provided a method for side dumping of a container vehicle, the method comprising: providing a deck for supporting the container vehicle, the deck pivotable about a longitudinal axis; providing a piston-cylinder assembly configured for pivoting the deck, a piston rod portion of the piston-cylinder assembly having a first end thereof supported against a support surface, a cylinder of the piston-cylinder assembly having an open end for receiving a second end of the piston rod portion, and a second cylinder end opposite the cylinder open end; and mechanically coupling the deck to the cylinder at a coupling location of the cylinder, the coupling location between the cylinder open end and the second cylinder end, wherein the piston-cylinder assembly is configured for coupling to an actuating system for actuating the piston-cylinder assembly between an extended position and a retracted position, thereby pivoting the deck.

### BRIEF DESCRIPTION OF THE FIGURES

These and other features of the invention will become more apparent in the following detailed description in which reference is made to the appended drawings.

FIG. 1A illustrates a cross-sectional schematic view of a vehicle side-dumping apparatus with its deck horizontal, according to the prior art.

FIG. 1B illustrates a cross-sectional schematic view of the vehicle side-dumping apparatus of FIG. 1A with its deck tilted.

FIG. 2A illustrates a cross-sectional schematic view of a vehicle side-dumping apparatus with its deck horizontal, in accordance with embodiments of the invention.

FIG. 2B illustrates a cross-sectional schematic view of the vehicle side-dumping apparatus of FIG. 2A with its deck tilted.

FIG. 3 illustrates a side view of a coupling assembly for coupling the deck to the cylinder, in accordance with embodiments of the present invention.

FIG. 4 illustrates a perspective view of an apparatus, in accordance with embodiments of the present invention.

FIG. 5 illustrates an end view of an apparatus with deck in the lowered position, in accordance with embodiments of the present invention.

FIG. 6 illustrates an end view of an apparatus with deck in the raised position, in accordance with embodiments of the present invention.

FIG. 7 illustrates a hinge connecting an upper deck structure to a lower deck structure in an apparatus, in accordance with embodiments of the present invention.

FIG. 8 illustrates a coupling assembly of an apparatus, in accordance with embodiments of the present invention.

FIG. 9 illustrates an underside view of an upper deck structure of an apparatus, in accordance with embodiments of the present invention.

FIG. 10 illustrates a partial view of an apparatus with a deck portion hidden, in accordance with embodiments of the present invention.

### DETAILED DESCRIPTION OF THE INVENTION

### Definitions

The term “container vehicle” is used to define a vehicle having a container thereon for holding material, the container having an opening generally near the top for accessing container contents. The opening may be uncovered or covered, for example with a movable or removable cover.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

An aspect of the present invention provides for an apparatus for side dumping of a container vehicle. The apparatus comprises a deck for supporting the container vehicle, and one or more piston-cylinder assemblies configured for pivoting the deck. The deck is pivotable about a longitudinal axis corresponding to normal direction of motion of the container vehicle. One or more hinges may be provided, for example along a longitudinal edge of the deck, to facilitate deck pivoting, the hinges connecting the deck to ground or to a grounded support structure. At least one piston-cylinder assembly comprises a piston rod portion having a first end supported against a support surface, such as ground or a grounded support structure. The piston rod portion first end may be pivotally connected to the support surface via a pin joint, ball joint, or other connection. The at least one piston-cylinder assembly further comprises a cylinder having an open end for receiving a second end of the piston rod portion, the second end connecting to a piston movably mounted inside the cylinder. The cylinder further comprises a second cylinder end opposite the open end. The at least one piston-cylinder assembly further comprises a coupling assembly, such as a trunnion assembly, configured to mechanically couple the deck to the cylinder at a coupling location of the cylinder. The coupling location is between the two cylinder ends, and may further be proximate to the cylinder open end, or at least more proximate to the cylinder open end than to the second cylinder end. The at least one piston-cylinder assembly is configured for coupling to an actuating system for actuating the piston-cylinder assembly between an extended position and a retracted position, thereby pivoting the deck. In some embodiments, the actuating system may form part of the present invention.

Conventionally, hydraulic or pneumatic piston-cylinder assemblies are typically configured with the cylinder end fixed to a support structure, for ease of attachment to hydraulic or pneumatic actuator system components such as fluid pumps, pipes, accumulators, and the like. In contrast, in embodiments of the present invention, the cylinder end is coupled to and moves with the vehicle deck as it tilts, while the piston rod portion is supported against a fixed structure such as ground. The cylinder end may therefore be coupled to the actuator system via flexible hydraulic tubing or piping, for example.

Also conventionally, and especially in platform tilting or dumping applications, hydraulic or pneumatic piston-cylinder assemblies are typically configured with attachment points at opposite ends. That is, the cylinder is typically attached to a fixed structure at a first end and receives a piston rod portion at a second, open end. The piston rod portion in turn is received by the cylinder at a first end, and is attached to a moving structure at a second end. In contrast, embodiments of the present invention are configured such that the cylinder is coupled to the tilting platform at a coupling location generally between the two cylinder ends, and/or proximate to the cylinder open end which receives a piston rod portion first end, the piston rod portion second end pivotally attached to or supported against a fixed structure.

In such a configuration, when the piston rod portion is retracted inside the piston cylinder, the cylinder coupling location and the piston rod portion second end are closer to each other than if the cylinder coupling location were at the cylinder end opposite the cylinder open end. Moreover, if the cylinder coupling location is located proximate to the cylinder open end, the cylinder coupling location and the piston rod portion second end are proximate or even adjacent when piston rod portion is retracted inside the piston cylinder. This facilitates providing a low-profile vehicle side tipping platform or apparatus which also has desirable load-handling characteristics, for example due to the piston-cylinder assembly being oriented generally in the direction in which force is to be applied for tipping the vehicle deck.

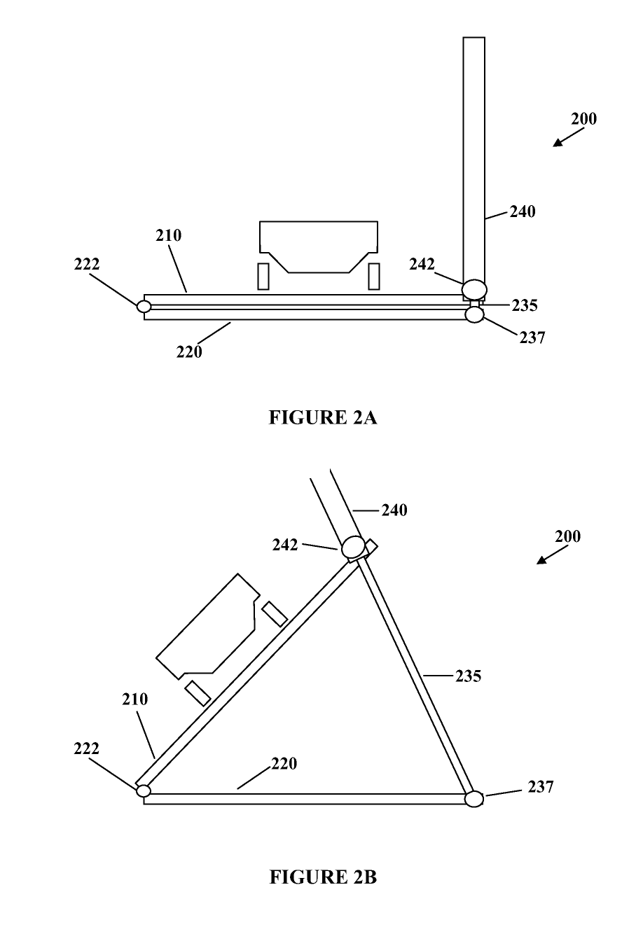

FIGS. 2A and 2B illustrate a cross-sectional schematic view of a vehicle side-dumping or tipping apparatus 200 in accordance with embodiments of the present invention. A vehicle deck 210 is mounted to a support structure 220 at a hinge point 222. A piston-cylinder assembly comprising a piston rod 235 and a cylinder 240 is configured for tilting the vehicle deck 210. A free end of the piston rod 235 is supported against the support structure 220 at a rod-end coupling location 237 and the cylinder 240 is coupled to the vehicle deck 210 at a coupling location 242, the coupling location 242 between the two ends of the cylinder 240 and, as illustrated, proximate to an open end of the cylinder 240 which receives the piston rod 235. FIG. 2A illustrates the apparatus 200 with the vehicle deck 210 horizontal for drive-on and drive-off, while FIG. 2B illustrates the apparatus 200 with the vehicle deck 210 tilted for dumping vehicle contents.

In some embodiments, the piston rod 235 may be coupled to the support structure 220 at the coupling location 237 via a pivotable coupling, such as a pin joint, trunnion assembly, ball joint, or the like. Likewise, in some embodiments the cylinder 240 may be coupled to the vehicle deck 210 at the coupling location 242 via a pivotable coupling, such as a pin joint, a pair of pin joints on either side of the cylinder, a trunnion assembly, one or more ball joints, or the like. Additionally, the hinge point 222 may comprise one or more hinges, pin joints, ball joints, rollers or wheels, or the like. Each of the coupling locations 237, 242 and the hinge point 222 may comprise a pivotable coupling enabling relative angular motion of various portions of the apparatus 200 for tipping operation thereof.

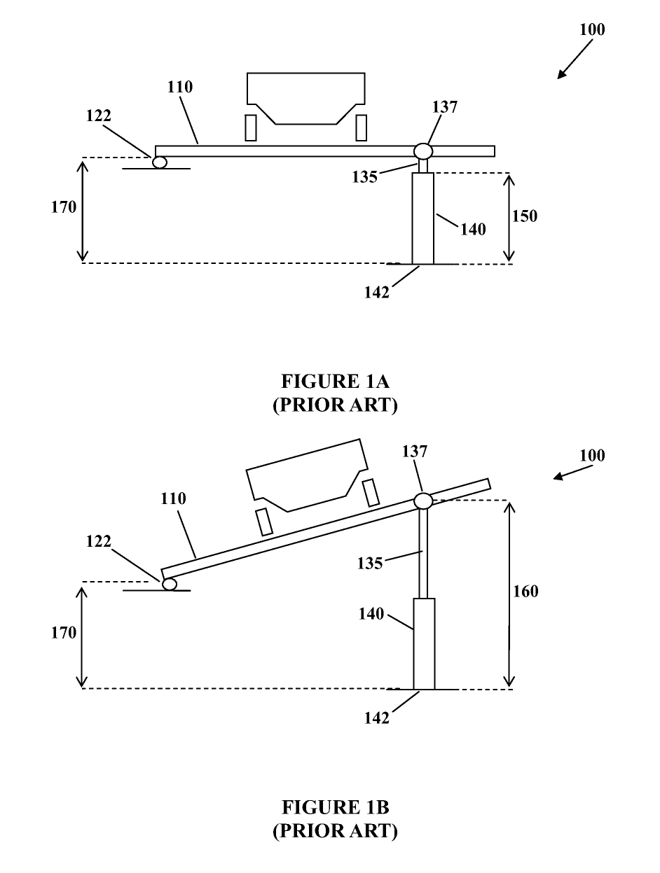

The apparatus 200 illustrated in FIGS. 2A and 2B differs from the apparatus 100 illustrated in FIG. 1 in several interrelated ways. First, the piston-cylinder assembly is essentially reversed, such that the cylinder 240 is coupled to the vehicle deck 210 instead of the piston rod, as is the case in FIG. 1. Second, the support structure 220 has a low profile, thereby reducing the need to excavate below the vehicle deck 210 or elevate the apparatus 200 above grade. In contrast, the support structure 120 illustrated in FIG. 1 extends a distance 170 below the pivot point 122. Third, the coupling location 242 of the cylinder is located between the two ends of the cylinder 240 and not at an end of the cylinder opposite an open end which receives the piston rod. The cylinder 240 therefore extends above the vehicle deck.

The support structure 220 may be a man-made support structure, for example comprising steel, concrete, or a combination thereof. The support structure 220 may comprise a natural support structure, such as a rock or earth bearing surface, possibly with concrete or steel components attached thereto for forming an anchor or bearing location of the coupling location 237 and/or the hinge point 222.

In some embodiments, for example as illustrated in FIG. 2, the piston rod portion may comprise a single piston rod, such as a rigid rod connected to a piston operating inside the cylinder of the piston-cylinder assembly. In some embodiments, the piston rod portion may be another structure, such as a portion of a telescoping piston-cylinder assembly, or another suitable arrangement of load-bearing components. The piston rod portion is movable within the cylinder of the piston-cylinder assembly at least in part by actuation of the piston. In the case of a telescoping assembly, the piston rod portion may further be extended by actuation of one or more additional pistons of further piston-cylinder assemblies nested within the piston rod portion.

As described above, the piston-cylinder assembly is pivotally coupled to both the support structure and the vehicle deck, the vehicle deck further pivotally coupled to a support structure. In such a configuration, not only does the vehicle deck sweep through an arc relative to the support structure during tilting, but the piston-cylinder assembly also sweeps through another arc during tilting of the vehicle deck in some embodiments, particularly when the pivotable couplings are at a fixed location. In embodiments of the present invention, the piston-cylinder assembly and pivot connections thereof are configured so as to support loads at each angular position during its sweep through such an arc.

In some embodiments, for example as illustrated in FIGS. 2A and 2B, the vehicle deck is supported along a first edge by one or more hinge points, and along a second edge by one or more piston rod portions. Thus, the cylinder of the piston-cylinder assembly, and the cylinder open end receiving the piston rod portion, may be located in or above the plane of the vehicle deck, or below but substantially near the plane of the vehicle deck. An advantage of this configuration is that the interface between the piston rod portion and the cylinder, and/or the cylinder itself, may not be subjected to certain loading stresses by the vehicle deck and vehicle supported thereby, when compared to, for example, this pivotal connection being at the centre of the cylinder length. Since the interface and/or the cylinder may not be particularly capable of withstanding bending stress when the piston-cylinder assembly is tilted at an angle, this configuration can provide an advantage in terms of strength and stability of the apparatus. Locating the interface above or near the vehicle deck may therefore reduce bending stress at weak points of the piston-cylinder assembly in embodiments of the present invention. For example, by locating the piston rod to cylinder interface, that is, the cylinder open end, near or above the vehicle deck, bending stress applied to both the cylinder and the piston rod to cylinder interface is reduced. In contrast, if the piston rod to cylinder interface were located at a substantial distance below the vehicle deck, a slight initial bend at the piston rod to cylinder interface may result in the interface being subjected to significant bending stresses, which may result in part strain or require reinforcement of the piston rod to cylinder interface. Embodiments of the present invention therefore avoid such a situation.

Embodiments of the present invention comprise a full-length vehicle deck attached, by way of a hinged joint, to a series of transverse beams located underneath and along the length of the deck. One or more hydraulic piston-cylinder assemblies are attached at a rod end thereof by way of a pin joint to the transverse beams and, at the cylinder body coupling location, by way of a trunnion assembly, to the deck. The one or more piston-cylinder assemblies facilitate tilting of the deck to enable gravitational discharge of material from vehicular mounted containers. A plurality of piston-cylinder assemblies may be coupled to the deck at various points along its length. The vehicle deck may be reinforced with stiffening beams so as to provide a deck which substantially resists bending or twisting to a predetermined extent.

In some embodiments, the one or more piston-cylinder assemblies may be operatively coupled to an actuating system, such as comprising a hydraulic power pack, hydraulic fluid lines and a control system for actuating the one or more piston-cylinder assemblies between extended and retracted positions, thereby pivoting the deck. The control system may be a volumetric control system for controlling hydraulic fluid volume to each piston-cylinder assembly. As would be readily understood by a worker skilled in the art, hydraulic fluid may be supplied into and out of a chamber of each cylinder to drive a piston therein. In some embodiments, the control system may comprise feedback control for balancing load and/or travel of each of a plurality of piston-cylinder assemblies so as to distribute loading and/or mitigate potential for deck bending or twisting. The control system may further include components such as local or remote user interfaces, alarms, lockouts, power couplings, service ports, primary and backup systems, and the like, as would be readily understood by a worker skilled in the art.

In some embodiments, the pistons are operatively coupled to the hydraulic power pack through hydraulic fluid lines which comprise a flexible portion. This configuration may be used particularly when the hydraulic power pack or other source of hydraulic fluid is located off of the vehicle deck. The hydraulic cylinders, which move with the vehicle deck as it is tilted, may thereby be operatively coupled to the source of hydraulic fluid while enabling relative motion between piston-cylinder assemblies and hydraulic fluid source. In some embodiments, the hydraulic fluid lines may be routed underneath the vehicle deck, with a flexible portion provided at least near the pivot axis of the vehicle deck. In some embodiments, flexible hydraulic fluid lines may be located along a side of the vehicle deck opposite the pivot axis side, for example hanging from the piston-cylinder assemblies.

In some embodiments, the hydraulic power pack or other source of hydraulic fluid may be mounted so as to move with the vehicle deck during tilting. For example, a hydraulic power pack may be mounted underneath or on top of the vehicle deck. In this embodiment there may be substantially no relative motion between the hydraulic fluid source and the cylinders, thereby enabling the hydraulic fluid lines to be made of a rigid material if desired, for example routed under the vehicle deck.

In accordance with embodiments of the present invention, the coupling assembly for coupling the deck to the cylinder at a coupling location of the cylinder is configured such that loading of the cylinder is substantially balanced, the piston-cylinder assembly being substantially axially loaded. For example, the coupling assembly may comprise a pair of coupling sub-assemblies situated on opposite sides of the cylinder, thereby substantially balancing load applied to said opposite sides, and reducing flexural forces in the cylinder. Each coupling sub-assembly may comprise a trunnion, pin, aperture for a pin, bearing assembly, or the like, for example, which transfers a load to the cylinder while facilitating relative rotation between the cylinder and the deck. Load balancing of the cylinder may reduce potential bending stress applied to the cylinder, which may reduce potential mechanical problems and/or allow for lower rigidity requirements of the piston-cylinder assembly.

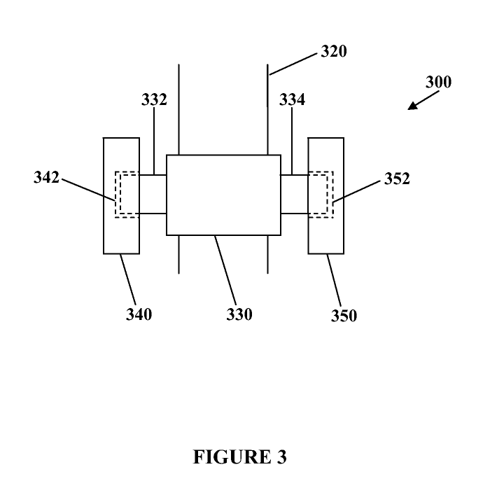

FIG. 3 illustrates a side view of a coupling assembly 300 for coupling the deck (not shown) to the cylinder 320 at a coupling location of the cylinder 320, in accordance with embodiments of the present invention. The coupling assembly 300 comprises a cylinder portion 330 coupled to the cylinder 320, for example by welding, and a pair of plates 340, 350 coupled to the deck. The coupling assembly cylinder portion 330 comprises a pair of trunnions 332, 334 protruding from the cylinder 320 from opposite sides thereof toward the plates 340, 350, respectively. The plates 340, 350 comprise apertures 342, 352, respectively, for receiving the trunnions 332, 334, rotatable within the apertures 342, 352, for providing a pivotable coupling. The cylinder 320 and coupling assembly 300 are situated between the plates 340, 350 within a region adjacent to the deck. For example, the plates 340, 350 may be coupled to a structure extending from an edge of the deck, or the deck may comprise a cut-out portion between the plates 340, 350 coupled thereto. The apertures 342, 352, may be blind apertures, as shown, or they may extend through the plates 340, 350, in which case the trunnions may also extend through the plates 340, 350 when fitted therein. In some embodiments, a bottom portion of the plates 340, 350 may be removed.

It will be readily understood that the present invention may be varied in terms of size, scale, loading capacity, and the like, for accommodating different vehicles or side dumping applications. In some embodiments, an apparatus of the present invention is configured for affixing to a pre-existing bearing surface, such as earth, concrete or rock, having sufficient bearing capacity. In this case, such a bearing surface may be adapted into a lower support structure to which the vehicle deck and piston rod portion are pivotally attached or mounted. In some embodiments, an apparatus of the present invention may be portable, so that it may be moved to different locations such as different transportation terminals as needed. Since embodiments of the present invention may be readily installed or affixed to a substantially flat surface without need for excavation or providing a structure above the surface, it may be relatively easily and quickly installed, thereby typically increasing portability and/or decreasing set-up time.

It will be appreciated that the coupling assembly may be varied in a variety of ways within the scope of the present invention. For example, each pin attaching a side of the cylinder to the deck may be a separate pin, with one end fitting into an aperture of a structure attached to the cylinder and another end fitting into an aperture of a structure attached to the deck. As another example, one end of the pin may be rigidly coupled to a structure attached to the cylinder, or to a structure attached to the deck. Pins may be pivotally coupled to the cylinder and/or deck structure by a pin joint, roller bearing or ball bearing assembly, ball joint, or other pivotable mechanical structure as would be readily understood by a worker skilled in the art.

In some embodiments, the coupling assembly may be integral to or otherwise coupled to one or both of the cylinder and the vehicle deck, for example by welding, bolting, or other appropriate means. In some embodiments, the coupling assembly may be non-rigidly coupled to one or both of the cylinder and the vehicle deck, for example by a spring assembly, damper system, shock absorption system, or the like.

In embodiments of the present invention, anchoring means, such as ropes or chains, are provided for securing the vehicle to the vehicle deck during side tipping. The anchoring means may be fastened to the vehicle before tilting of the vehicle deck, thereby inhibiting vehicle rollover.

In some embodiments, the present invention provides for a vehicular side dumping system to be established at a transportation terminus with zero or minimal required ground excavation. Where excavation of the ground is impractical, or impossible, the low profile nature of an apparatus in accordance with the present invention may result in little or no required ramping to elevate the roadway to the height of the deck.

In some embodiments, the degree to which ramping, and, or, excavation are required may be a function of the compressive strength of the bearing material onto which the platform structure is sited. For a bearing material with sufficient bearing strength, embodiments of the present invention may be provided without the lower structure, such that the hinge points for the platform and piston rod portions are attached directly or via a bearing pad or connection to the bearing surface.

Embodiments of the present invention, when mounted to the lower structure, may be mobilized and transported from site to site as a single unit without the need for extensive disassembly. The lower structure transverse beams may feature bolting provision for interchangeable end plates such that the unit may be attached to the bearing surface with a variety of bolting configurations and orientations. The hydraulic power pack may be skid mounted and non-rigidly plumbed to allow flexible locating and mobility.

Embodiments of the present invention are orientation non-specific and may be configured for left or right handed tipping.

Embodiments of the present invention are scalable for various vehicle masses and lengths. In some embodiments, the present invention is appropriate for a gross vehicle mass of 72300 kg with the platform mounting onto an elevated roadway formed from an inverted concrete channel with a compressive strength no greater than 25 MPa.

Embodiments of the present invention comprise automatic hydraulic flow control, for example volumetric flow control, such that multiple hydraulic cylinders can be synchronized to substantially equally load share a vehicle's potentially unevenly distributed load. In some embodiments, the present invention may be scaled to cope with a greater or lesser degree of non-uniformly distributed load. Embodiments of the present invention may thus reduce torsional loading of the deck due to the unbalance between cylinders and platform loads.

The invention will now be described with reference to specific examples. It will be understood that the following examples are intended to describe embodiments of the invention and is not intended to limit the invention in any way.

### EXAMPLES

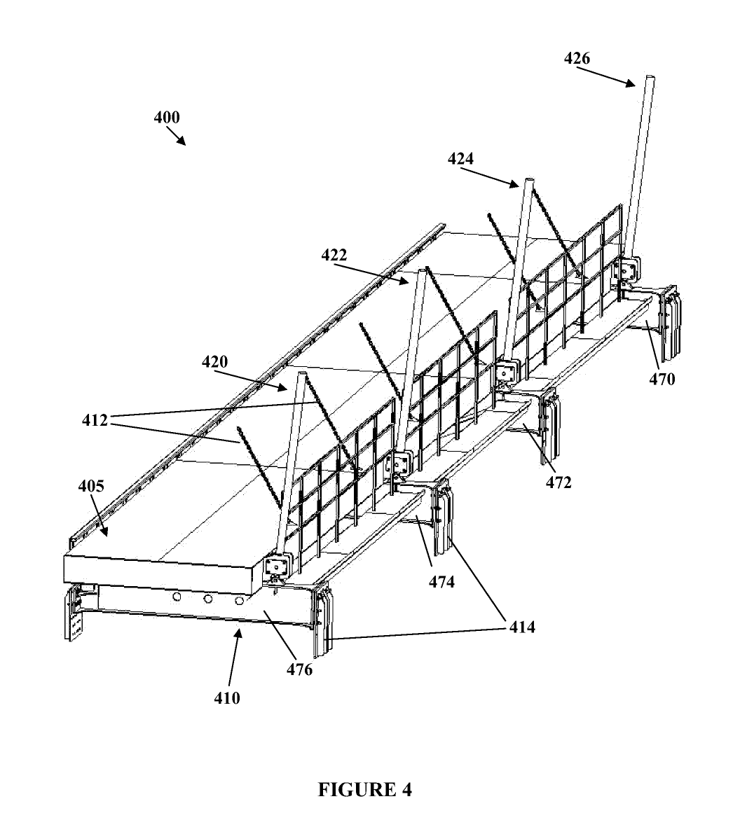

FIG. 4 illustrates a perspective view of a side dumping platform apparatus 400 for gravitational discharge of product from a suitable transportation vehicle, in accordance with embodiments of the present invention. The side dumping platform comprises an upper deck structure 405 and an optional lower deck structure 410 and/or suitable connection points on a lower bearing surface. FIG. 4 further illustrates chains, such as chains 412 for anchoring a vehicle to the vehicle deck, and bolt plates, such as bolt plates 414 for attaching the lower deck structure 410 to a ground surface or structure such as rock, concrete, steel, earth, or the like.

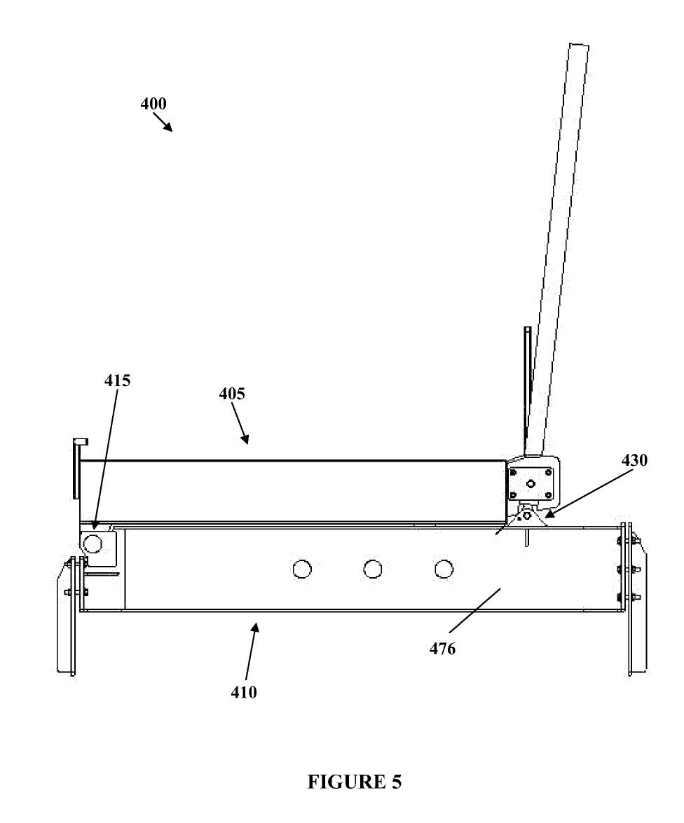

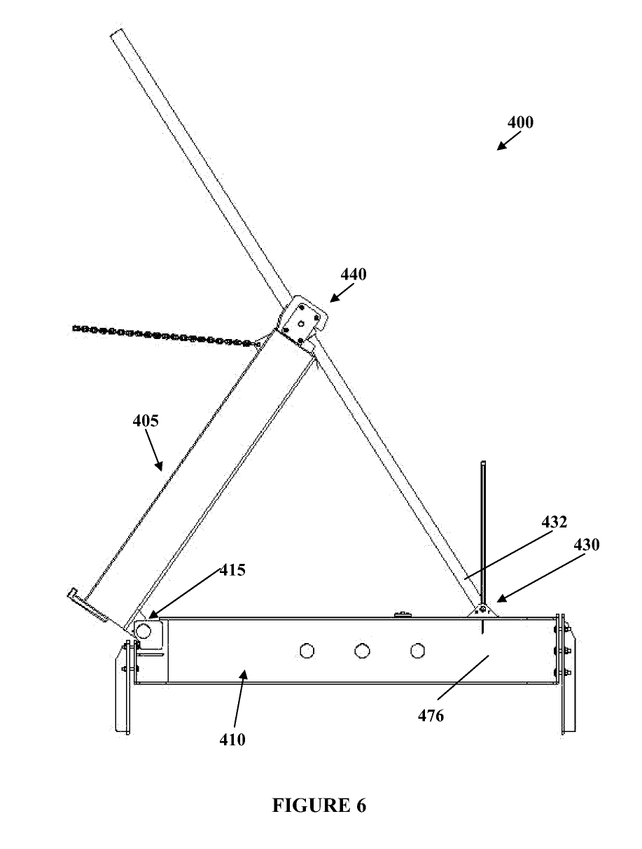

As illustrated in FIGS. 5 and 6, the upper deck structure 405 and the lower structure 410 or lower bearing surface are connected at one side by a hinge 415, such as a non-continuous hinge, such that the upper deck structure 405 is pin jointed and can rotate about a longitudinal axis through an arc relative to the fixed lower structure 410 or lower bearing surface. FIG. 5 illustrates an end view of the side dumping platform apparatus 400 with the upper deck structure 405 in a lowered position, and FIG. 6 illustrates an end view of the side dumping platform apparatus 400 with the upper deck structure 410 in a raised position.

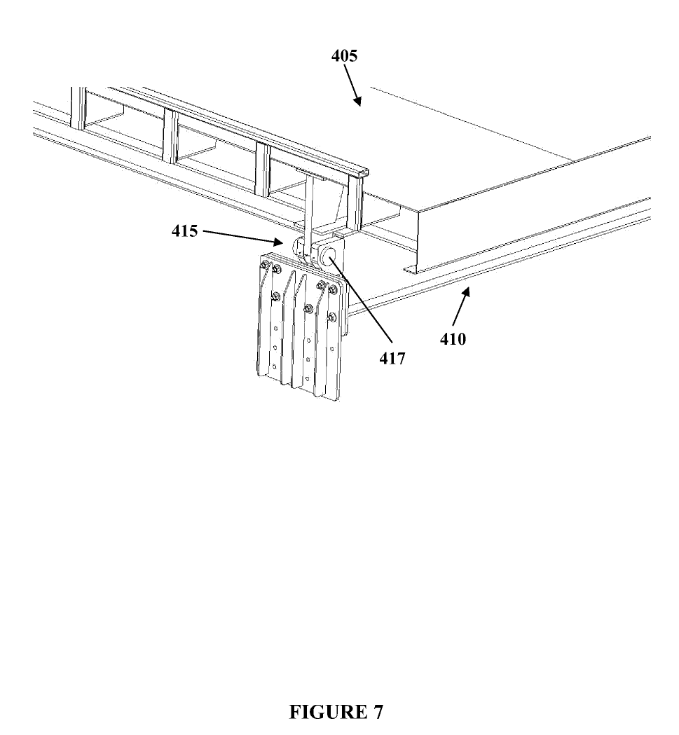

FIG. 7 illustrates a perspective view of the hinge 415 connecting the upper deck structure 405 to the lower deck structure 410 or lower bearing surface. As illustrated, the hinge comprises a pin joint comprising a pin 417 fitted into apertures of protruding hinge structures connected to the upper deck structure 405 and the lower deck structure 410. A plurality of such pin joints may be provided at intervals along a longitudinal axis of the apparatus 400. Other types of hinges, such as comprising bearing assemblies, flexible material, wheels, rollers, or the like, may also be used in place of pin joints.

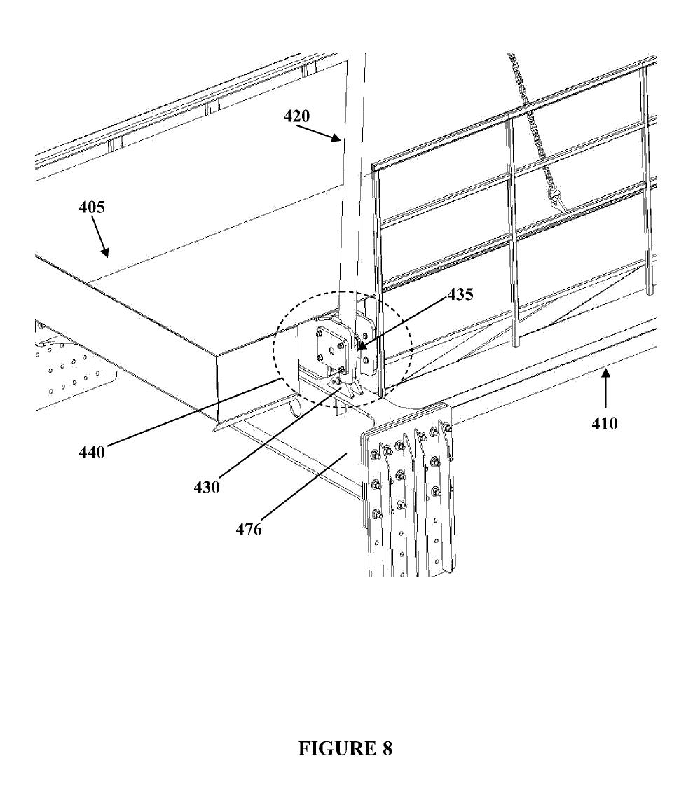

Movement of the upper deck structure 405 is effected by means of a plurality of hydraulic piston-cylinder assemblies 420, 422, 424, 426, illustrated in FIG. 4. As illustrated for example in FIG. 6, a hydraulic piston-cylinder assembly, such as 420 is pivotally connected, at its rod end 432, via a pin joint structure 430 to the lower structure 410 or bearing surface. As illustrated in FIG. 8, the hydraulic piston-cylinder assembly 420 is further pivotally connected at a coupling point 435 near the cylinder end, to the upper deck structure 405, by means of a coupling assembly 440 such as a trunnion assembly. In this way extension of the cylinder affects differential movement, in rotation, between the upper and lower structures.

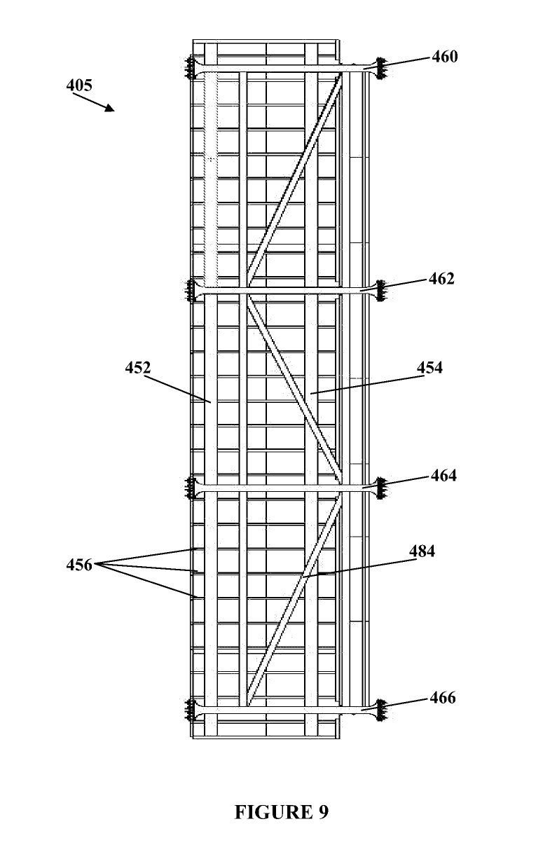

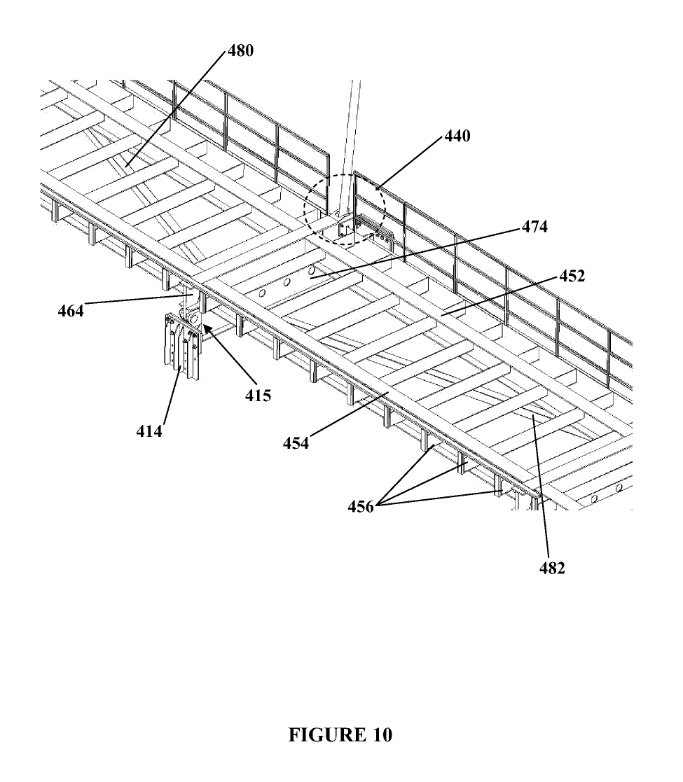

FIG. 9 illustrates an underside view of the upper deck structure 405, and FIG. 10 illustrates a partial view of the apparatus 400 with the deck portion of the upper deck structure hidden. The upper deck structure provides the main support surface for the vehicle during tipping and comprises a substantially full length and width continuous or substantially continuous deck. The deck is supported by two full length longitudinal beams 452, 454, substantially coincident with the width-wise location of the vehicle's wheels centers of pressure. The deck structure is further supported by substantially evenly spaced transverse beams or cross members, such as beams 456, each of which substantially span the full width of the underside of the deck and which form an array substantially spanning the full length of the deck.

An additional series of transverse beams or upper hinge beams 460, 462, 464, 466, located parallel to the cross members 456, are coupled at a first end to the hinge structure 415 and at a second end to the coupling assembly 440 for the cylinder body. The upper hinge beams 460, 462, 464, 466 terminate, at the first end, approximately flush with the width-wise extremity of the deck and at the second end continue past the deck so that the cylinder may be mounted, at the coupling assembly 440 at a location clear of the deck structure.

As illustrated for example in FIGS. 4 and 10, the lower structure 410 comprises four transverse beams or lower hinge beams 470, 472, 474, 476 located substantially coincident with but immediately below the upper hinge beams 460, 462, 464, 466, respectively. A first end of the lower hinge beams 470, 472, 474, 476 is coupled to the hinge structure 415 and a second end is coupled to the pin joint structure 430 for the cylinder rod end. In this and other embodiments both ends of the lower hinge beams 470, 472, 474, 476 are coupled to bolt plates 414 for attachment to a concrete or other structure. This design can be readily adapted to suit connection to alternative structures, or directly to cast-in anchors. In this and other embodiments the lower hinge beams 470, 472, 474, 476 are connected together with a series of diagonal and longitudinal bracing, for example 480, 482 illustrated in FIG. 10. Similarly, the upper structure 405 may comprise diagonal, longitudinal and/or lateral bracing, for example 484 illustrated in FIG. 9. This bracing allows the unit to be transported as a single structure and provides additional longitudinal stiffness required specifically for this embodiment as the concrete structure onto which the unit is mounted is of unknown structural integrity. In some embodiments, given a combination of ground surface and cast-in anchors of sufficient compressive and tensile strength the lower structure 410 may be eliminated.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. An apparatus for side dumping of a container vehicle, the apparatus comprising:
a. a deck for supporting the container vehicle, the deck pivotable about a longitudinal axis;
b. a piston-cylinder assembly configured for pivoting the deck, a piston rod portion of the piston-cylinder assembly having a first end thereof supported against a support surface, a cylinder of the piston-cylinder assembly having an open end for receiving a second end of the piston rod portion, and a second cylinder end opposite the cylinder open end; and
c. a coupling assembly configured to mechanically couple the deck to the cylinder at a coupling location of the cylinder, the coupling location between the cylinder open end and the second cylinder end,
wherein the piston-cylinder assembly is configured for coupling to an actuating system for actuating the piston-cylinder assembly between an extended position and a retracted position, thereby pivoting the deck.

2. The apparatus of claim 1, wherein the coupling location is proximate to the cylinder open end.

3. The apparatus of claim 1, wherein the coupling location is within a plane of the deck.

4. The apparatus of claim 1, wherein the coupling assembly comprises a first coupling sub-assembly configured to pivotally couple the deck to a first side of the cylinder, and a second coupling sub-assembly configured to pivotally couple the deck to a second side of the cylinder opposite the first side of the cylinder.

5. The apparatus of claim 1, wherein the coupling assembly comprises one or more pivotable couplings selected from the group comprising: pin joints, trunnion assemblies, and bearing assemblies.

6. The apparatus of claim 1, wherein the piston rod portion is pivotally coupled to the support surface.

7. The apparatus of claim 1, further comprising a low-profile structure situated below the deck, the low-profile structure comprising:
a. the support surface supporting the piston rod portion first end;
b. a pivot region pivotally connected to the deck via one or more hinges along the longitudinal axis; and
c. one or more deck support regions configured to support the deck when the piston-cylinder assembly is in the retracted position.

8. The apparatus of claim 1, wherein the piston-cylinder assembly is generally perpendicular to the deck when in the retracted position.

9. The apparatus of claim 1, wherein the apparatus is portable.

10. A method for side dumping of a container vehicle, the method comprising:
a. providing a deck for supporting the container vehicle, the deck pivotable about a longitudinal axis;
b. providing a piston-cylinder assembly configured for pivoting the deck, a piston rod portion of the piston-cylinder assembly having a first end thereof supported against a support surface, a cylinder of the piston-cylinder assembly having an open end for receiving a second end of the piston rod portion, and a second cylinder end opposite the cylinder open end; and
c. mechanically coupling the deck to the cylinder at a coupling location of the cylinder, the coupling location between the cylinder open end and the second cylinder end,
wherein the piston-cylinder assembly is configured for coupling to an actuating system for actuating the piston-cylinder assembly between an extended position and a retracted position, thereby pivoting the deck.

11. The method of claim 10, wherein the coupling location is proximate to the cylinder open end.

12. The method of claim 10, wherein the coupling location is within a plane of the deck.

13. The method of claim 10, wherein mechanically coupling the deck to the cylinder is performed via a coupling assembly comprising a first coupling sub-assembly configured to pivotally couple the deck to a first side of the cylinder, and a second coupling sub-assembly configured to pivotally couple the deck to a second side of the cylinder opposite the first side of the cylinder.

14. The method of claim 10, wherein mechanically coupling the deck to the cylinder is performed via a coupling assembly comprising one or more pivotable couplings selected from the group comprising: pin joints, trunnion assemblies, and bearing assemblies.

15. The method of claim 10, wherein the piston rod portion is pivotally coupled to the support surface.

16. The method of claim 10, further comprising providing a low-profile structure situated below the deck, the low-profile structure comprising:
a. the support surface supporting the piston rod portion first end;
b. a pivot region pivotally connected to the deck via one or more hinges along the longitudinal axis; and
c. one or more deck support regions configured to support the deck when the piston-cylinder assembly is in the retracted position.

17. The method of claim 10, wherein the piston-cylinder assembly is generally perpendicular to the deck when in the retracted position.

18. The method of claim 10, wherein the deck and the piston-cylinder assembly are portable.
